(19) United States
(12) Patent Application Publication
(10) Pub. No.: US 2013/0343532 A1
(43) Pub. Date: Dec. 26, 2013

(54) Call Queues with Audiovisual and Interactive Content

(71) Applicant: Barrington A. Castle, Saratoga, CA (US)

(72) Inventor: Barrington A. Castle, Saratoga, CA (US)

(73) Assignee: Microsoft Corporation, Redmond, WA (US)

(21) Appl. No.: 13/531,212

(22) Filed: Jun. 22, 2012

(51) Int. Cl. H04M 3/42

(52) U.S. Cl. 379/215.01

(57) ABSTRACT

Various embodiments can utilize audiovisual and/or interactive content to present to a caller when the caller's call is placed into a call queue. A variety of different types of content can be presented to the caller to reduce the caller's perceived time in the call queue. In at least some embodiments, content presented to a particular caller can be driven by caller selections. Alternately or additionally, content presented to a particular caller can be automatically selected for the caller based upon information associated with the caller such as the caller's profile and/or information associated with the caller's previous content consumption patterns.

### BACKGROUND

Call queues are utilized to handle large numbers of calls from various users. Typically, when a caller is placed in a call queue, they are placed on hold and have to wait for a next available person with whom to speak. Sometimes, the waiting time experienced by a caller in a call queue can span several minutes, leading to frustration and impatience. Needless to say, many callers have bad experiences when forced to wait several minutes for a next available person or agent with whom to speak.

### SUMMARY

This Summary is provided to introduce a selection of concepts in a simplified form that are further described below in the Detailed Description. This Summary is not intended to identify key features or essential features of the claimed subject matter.

Various embodiments can utilize audiovisual and/or interactive content to present to a caller when the caller's call is placed into a call queue. A variety of different types of content can be presented to the caller to reduce the caller's perceived time in the call queue. In at least some embodiments, content presented to a particular caller can be driven by caller selections. Alternately or additionally, content presented to a particular caller can be automatically selected for the caller based upon information associated with the caller such as the caller's profile and/or information associated with the caller's previous content consumption patterns.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 illustrates an example client architecture in accordance with one or more embodiments.

FIG. 3 illustrates an example client application in accordance with one or more embodiments.

FIG. 4 illustrates an example client application in accordance with one or more embodiments.

FIG. 5 illustrates an example client application in accordance with one or more embodiments.

FIG. 6 illustrates an example client application in accordance with one or more embodiments.

FIG. 7 illustrates an example client application in accordance with one or more embodiments.

FIG. 8 is a flow diagram that describes steps in a method in accordance with one or more embodiments.

FIG. 9 illustrates an example system that includes the various end user terminals as described with reference to FIG. 1.

### DETAILED DESCRIPTION

Overview

Various embodiments can utilize audiovisual and/or interactive content to present to a caller when the caller's call is placed into a call queue. A variety of different types of content can be presented to the caller to reduce the caller's perceived time in the call queue. In at least some embodiments, content presented to a particular caller can be driven by caller selections. Alternately or additionally, content presented to a particular caller can be automatically selected for the caller based upon information associated with the caller such as the caller's profile and/or information associated with the caller's previous content consumption patterns.

In the discussion that follows, an example environment is described in which audiovisual and/or interactive content can be presented to a caller in accordance with one or more embodiments. Following this, a section entitled “Presentation of Audiovisual and/or Interactive Content” describes various examples of how content can be presented to a caller in accordance with one or more embodiments. Next, a section entitled “Example Audiovisual or Interactive Content” describes example content that can be presented to a caller in accordance with one or more embodiments. Following this, a section entitled “Using Caller Information to Influence Presentation of Material” describes various embodiments of how content can be automatically presented to a caller in accordance with one or more embodiments. Last, section entitled “Example System and Devices” describes an example system and various devices that can be utilized to implement one or more embodiments.

Consider now an example environment in which various embodiments can be practiced.

Example Environment

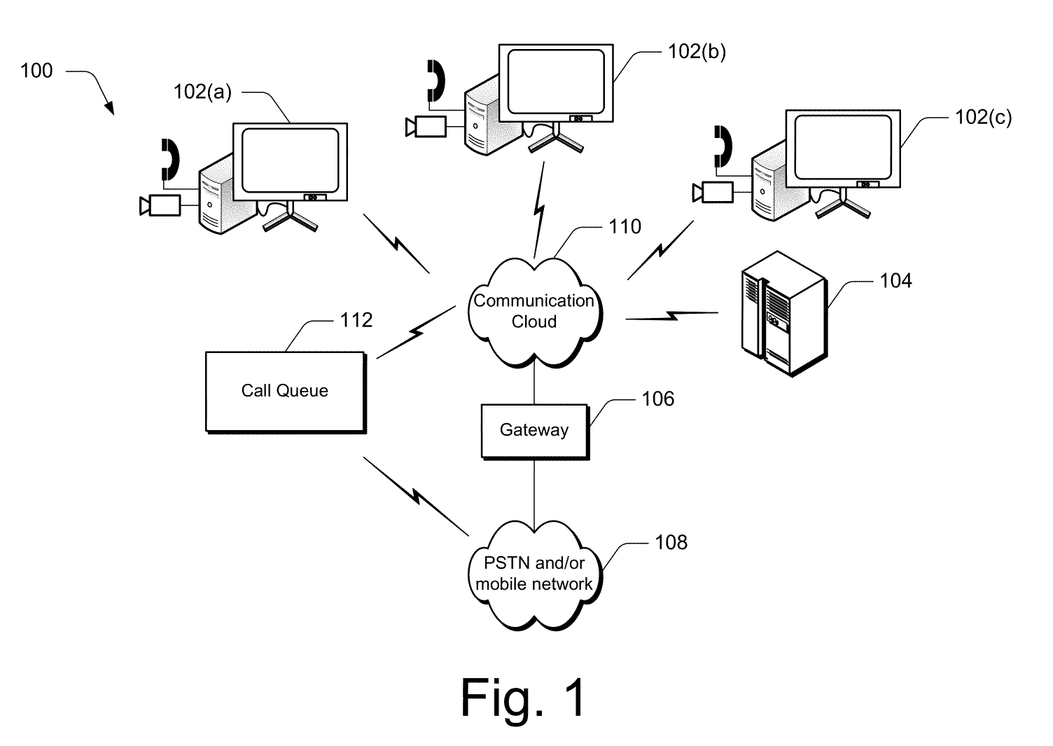

FIG. 1 is a schematic illustration of a communication system 100 implemented over a packet-based network, here represented by communication cloud 110 in the form of the Internet, comprising a plurality of interconnected elements. Each network element is connected to the rest of the Internet, and is configured to communicate data with other such elements over the Internet by transmitting and receiving data in the form of Internet Protocol (IP) packets. Each element also has an associated IP address locating it within the Internet, and each packet includes a source and destination IP address in its header. The elements shown in FIG. 1 include a plurality of end-user terminals 102(a) to 102(c), such as desktop or laptop PCs or Internet-enabled mobile phones, a server 104 such as a peer-to-peer server of an Internet-based communication system, and a gateway 106 to another type of network 108 such as to a traditional Public-Switched Telephone Network (PSTN) or other circuit switched network, and/or to a mobile cellular network. However, it will of course be appreciated that many more elements make up the Internet than those explicitly shown. This is represented schematically in FIG. 1 by the communications cloud 110 which typically includes many other end-user terminals, servers and gateways, as well as routers of Internet service providers (ISPs) and Internet backbone routers.

Communication system 100 also includes one or more call queues 112. These call queues can be implemented using any suitable type of technology. For example, in at least some embodiments, one or more of the call queues can be implemented, at least in part, by an Automatic Call Distributor (ACD) that is a device or system that distributes incoming phone calls from callers to a specific group of terminals that various agents can use. These types of systems are typically employed by entities, such as offices or businesses, which handle large volumes of incoming phone calls from callers who have no need to talk to a specific person, but rather seek assistance from any of multiple persons such as, by way of example and not limitation, customer service representatives. ACD systems typically include hardware for the terminals and switches, phone lines, and software that implements routing strategy. The routing strategy is a rule-based set of instructions that tells the ACD how calls are to be handled inside the system. In at least some instances, these rules or algorithms determine a desirable available employee or employees to respond to a given incoming call. To help make this match, additional data can be solicited and reviewed to ascertain why the caller is calling.

In the illustrated and described embodiment, end-user terminals 102(a) to 102(c) can communicate with one another, as well as other entities, by way of the communication cloud using any suitable techniques. Thus, end-user terminals can communicate with an entity having a call queue 112 through the communication cloud 110 and/or through the communication cloud 110, gateway 106 and network 108 using, for example Voice over IP (VoIP). In order to communicate with another end user terminal, a client executing on an initiating end user terminal acquires the IP address of the terminal on which another client is installed. This is typically done using an address look-up.

Some Internet-based communication systems are managed by an operator, in that they rely on one or more centralized, operator-run servers for address look-up (not shown). In that case, when one client is to communicate with another, then the initiating client contacts a centralized server run by the system operator to obtain the callee's IP address.

In contrast to these operator managed systems, another type of Internet-based communication system is known as a “peer-to-peer” (P2P) system. Peer-to-peer (P2P) systems typically devolve responsibility away from centralized operator servers and into the end-users' own terminals. This means that responsibility for address look-up is devolved to end-user terminals like those labeled 102(a) to 102(c). Each end user terminal can run a P2P client application, and each such terminal forms a node of the P2P system. P2P address look-up works by distributing a database of IP addresses amongst some of the end user nodes. The database is a list which maps the usernames of all online or recently online users to the relevant IP addresses, such that the IP address can be determined given the username.

Once known, the address allows a user to establish a voice or video call, or send an IM chat message or file transfer, etc. Additionally however, the address may also be used when the client itself needs to autonomously communicate information with another client.

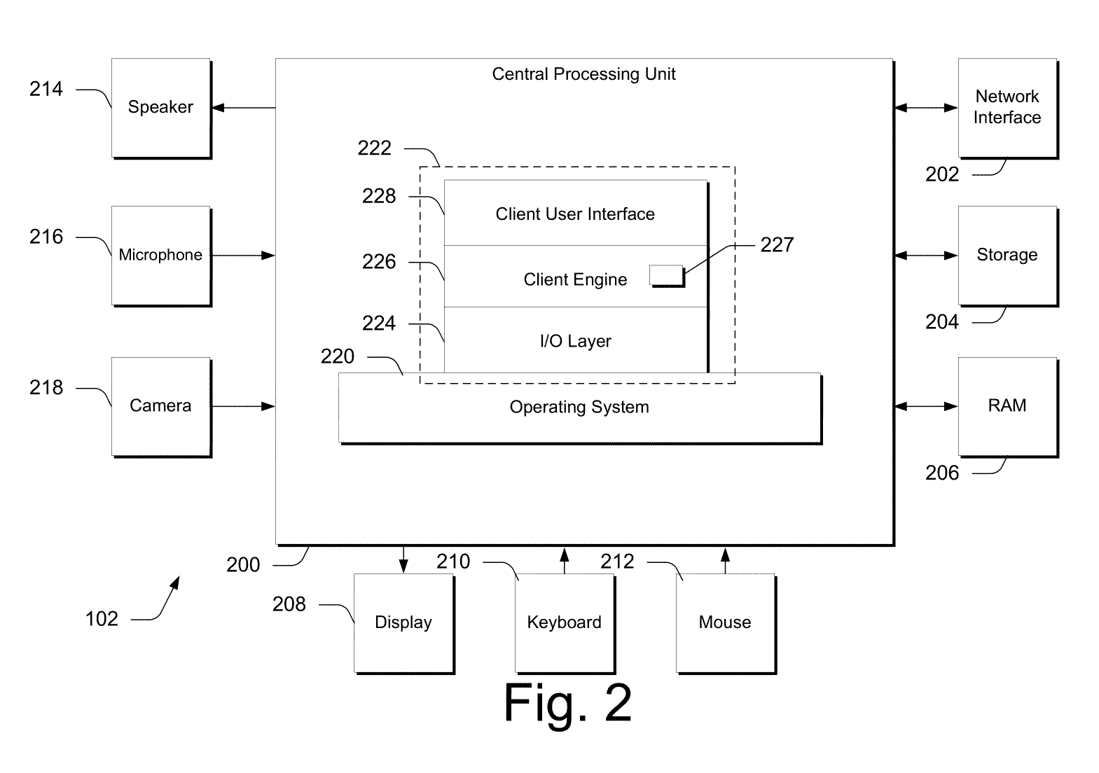

The schematic block diagram of FIG. 2 shows an example of an end-user terminal 102, which is configured to act as a terminal of a system operating over the Internet. The system may comprise a P2P system and/or a non-P2P system. The terminal 102 comprises a processor or CPU 200 operatively coupled to: a network interface 202 such as modem or other interface for connecting to the Internet, a non-volatile storage device 204 such as a hard-drive or flash memory, and a volatile memory device such as a random access memory (RAM) 206. The terminal 102 also comprises one or more user input devices, for example in the form of a keyboard or keypad 210, a mouse 212, a microphone 216 and a camera 218 such as a webcam, each operatively coupled to the CPU 200. The terminal 102 further comprises one or more user output devices, for example in the form of a display 208 and speaker 214, again each operatively coupled to the CPU 200.

The storage device 204 stores software including at least an operating system (OS) 220, and packet-based communication software in the form of a client application 222 which may comprise a P2P application and/or a non-P2P application through which communication can take place over a network, such as the networks described in FIG. 1. On start-up or reset of the terminal 102, the operating system 220 is automatically loaded into the RAM 206 and from there is run by being executed on the CPU 200. Once running, the operating system 220 can then run applications such as the client application 222 by loading them into the into the RAM 206 and executing them on the CPU 200. To represent this schematically in FIG. 2, the operating system 220 and client application 222 are shown within the CPU 200.

The client application 222 comprises a “stack” having three basic layers: an input and output (I/O) layer 224, a client engine layer 226, and a client user interface (UI) layer 228. The functionality of these layers can be implemented by an architecture other than the one specifically depicted without departing from the spirit and scope of the claimed subject matter.

Each layer or corresponding functionality module is responsible for specific functions. Because each successive layer usually communicates with two adjacent layers (or one in the case of the top layer), they are regarded as being arranged in a stack as shown in FIG. 2. The client application 222 is said to be run “on” the operating system 220. This means that in a multi-tasking environment it is scheduled for execution by the operating system 220; and further that inputs to the lowest (I/O) layer 224 of the client application 222 from network interface 202, microphone 216 and camera 218 as well as outputs from the I/O layer 224 to network interface 202, display 208 and speaker 214 may be mediated via suitable drivers and/or APIs of the operating system 220. In at least some embodiments, the client application 222 can be implemented to include a web-based interface that can be utilized to present audiovisual and interactive content, as described below.

The I/O layer 224 of the client application comprises a voice engine and optionally a video engine in the form of audio and video codecs which receive incoming encoded streams and decode them for output to speaker 214 and/or display 208 as appropriate, and which receive unencoded audio and/or video data from the microphone 216 and/or camera 218 and encodes them for transmission as streams to other end-user terminals 102 of a P2P system, or other entities in a PSTN and/or mobile network such as network 108. The I/O layer 224 may also comprises a control signaling protocol for signaling control information between terminals 102 of the network.

The client engine layer 226 then handles the connection management functions of the system as discussed above, such as establishing calls or other connections by P2P address look-up and authentication, as well as by other techniques. The client engine may also be responsible for other secondary functions of the system such as supplying up-to-date contact lists and/or avatar images of the user to the server 104 (FIG. 1); or retrieving up-to-date contact lists of the user and retrieving up-to-date avatar images of other users from the server 104.

Further, the client engine layer 226 comprises a call queue module 227 configured to perform call queue processing as described above and below. Such can include providing a user experience that leverages the use of audiovisual and/or interactive content as described below.

The client user interface layer 228 is responsible for presenting decoded content, such as audiovisual and/or interactive content to the user via the display 208, for presenting the output on the display 208 along with other information such as presence and profile information and user controls such as buttons and menus, and for receiving inputs from the user via the presented controls. In at least some embodiments, the client user interface layer 228 can include a web-based interface, such as an additional window contained within the overall user interface that can be utilized to present audiovisual and/or interactive content when a call is placed in a call queue.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the end user terminal 102 may also include an entity (e.g., software) that causes hardware or virtual machines of the end user terminal 102 to perform operations, e.g., processors, functional blocks, and so on. For example, the end user terminal 102 may include a computer-readable medium that may be configured to maintain instructions that cause the end user terminal, and more particularly the operating system and associated hardware of the end user terminal 102 to perform operations. Thus, the instructions function to configure the operating system and associated hardware to perform the operations and in this way result in transformation of the operating system and associated hardware to perform functions. The instructions may be provided by the computer-readable medium to the end user terminal 102 through a variety of different configurations.

One such configuration of a computer-readable medium is signal bearing medium and thus is configured to transmit the instructions (e.g., as a carrier wave) to the end user terminal, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Presentation of Audiovisual and/or Interactive Content

In one or more embodiments, a client application, such as client application 222, can be configured to provide communication services with configurable options and multi-modal content to users when their call is placed in a call queue. This can be done to influence callers to stay in the call queue while they wait to be connected to an intended call recipient, such as a live agent. The client application can be configured to display any suitable type of content including audiovisual content and/or interactive content. In at least some embodiments, such content can be tailored to a caller's interest based upon a number of different discoverable parameters, as will be described below.

As noted above, any suitable type of audiovisual content and/or interactive content can be displayed. By way of example and not limitation, such content can include videos such as promotional or informational videos, product brochures, documentation, frequently asked questions (FAQs) which may or may not include images or videos, product customization interfaces that allow users to interactively experience one or more products that may be of interest, virtual-reality interfaces in which a user can be permitted to navigate through a virtual space that contains content that might be of interest to the user, game interfaces in which a user can play a game while they wait in the call queue, and/or a virtual jukebox that provides an ability for a caller to select music and/or video content from a list that can be displayed for them while they wait in the call queue.

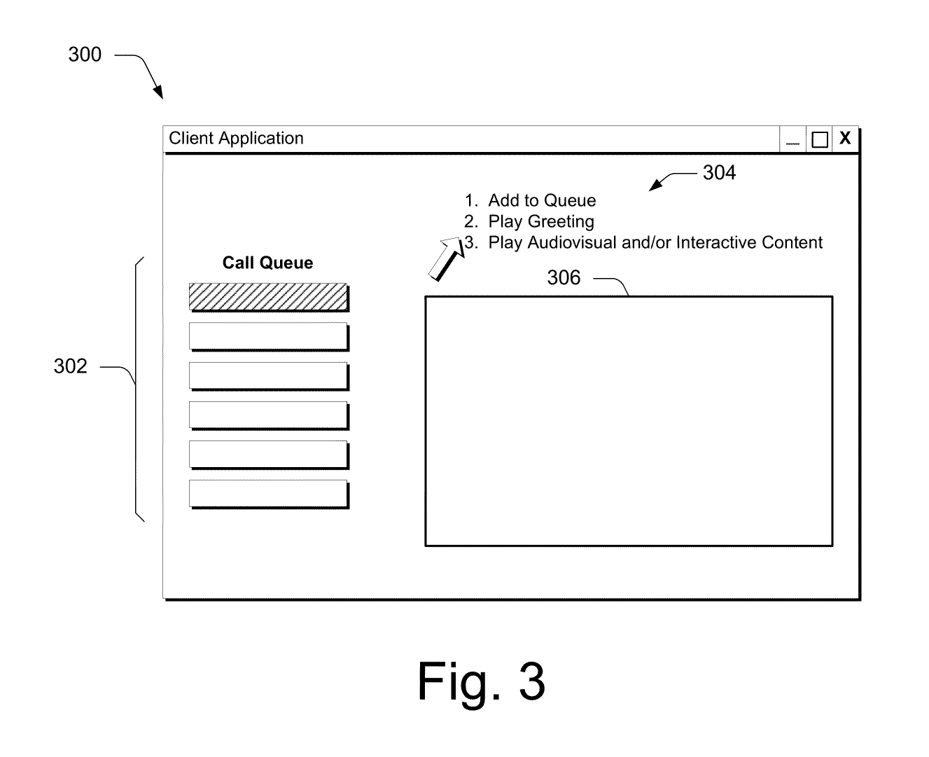

FIG. 3 illustrates an example client application user interface generally at 300, in accordance with one or more embodiments. In this example, a caller has placed a call using their client application to an entity that has a call queue. The call can be initiated in any suitable way. For example, the call may have been initiated responsive to a caller selecting an item on a particular webpage, such as a particular product or service. Alternately or additionally, the call may have been initiated by a user directly calling a particular entity.

An example call queue is illustrated at 302. In one or more embodiments, user interface 300 includes an options section 304 that provides a number of different options for a user to select when they call an entity. In the illustrated example, one option is to opt to be added to the call queue. In this particular instance, assume that the user has clicked this option and is now added to the call queue as indicated by the crosshatched rectangle. The crosshatched rectangle represents the user's position in call queue 302. Other options can include, by way of example and not limitation, options to play a greeting and options to play audiovisual and/or interactive content. The audiovisual and/or interactive content can be displayed in a window 306. Alternately or additionally, this content may be displayed in a separate window that is not visually contained within the user interface 300. For example, selecting this option might cause a browser application to launch within which the content can be displayed.

Having considered an example user interface in accordance with one or more embodiments, consider now various examples of audiovisual and/or interactive content that can be provided when a call is placed in a call queue.

Example Audiovisual or Interactive Content

As noted above, any suitable type of audiovisual and/or interactive content can be displayed when a call is placed in a call queue. The following constitute but examples only and are not intended to limit the scope of the claimed subject matter.

Promotional or Informational Videos

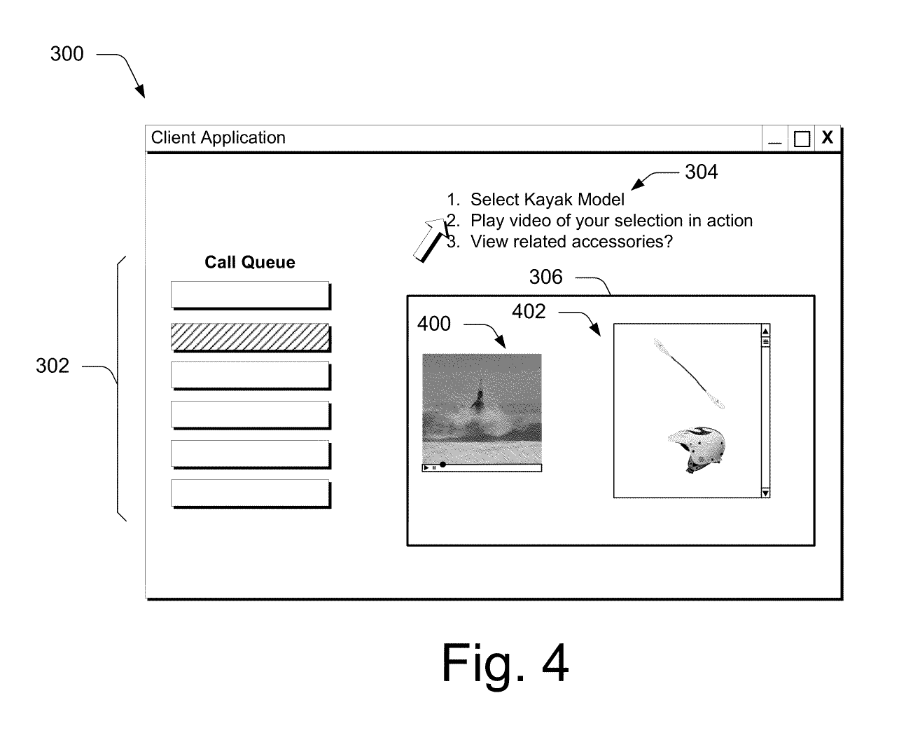

In at least some embodiments, audiovisual and/or interactive content can include promotional or informational videos. As an example, consider the following. Assume that a user is browsing a website that sells sports equipment and clothing. The user may be interested in a particular ocean kayak. By clicking a link associated with the ocean kayak, the user can cause, through their client application, initiation of a call to the purveyor of the sports equipment. The call is routed to an automated call attendant which, in turn, causes the user interface shown in FIG. 3 to be presented to the user. At this point, the user can opt to be added to the call queue 302 and can further select an option to view audiovisual or interactive content in the form of promotional or informational videos. Once selected, the promotional or informational videos can be sent to the client application for display in window 306. In this particular example, the promotional or informational videos may show the ocean kayak in which the user is interested being used in the ocean. Additionally, informational videos on kayak safety may also be presented to the user while they are in the call queue. As an example, consider FIG. 4. There, user interface 300 is shown. Assume in this example that selections that are presented to the user include a selection in which they can select a kayak model, play video of a related model selection, and/or view related accessories. In this particular example, the user has opted to play video of their selected kayak model. Responsive to their selection, a sub-window 400 with video controls is presented and a video of their selected kayak model is shown in action. Assume further, that the user selects to view related accessories. In this example, a sub-window 402 is presented and a user can scroll through related accessory options while in the call queue.

Further, in at least some embodiments, advertising material related to the subject of the user's call may be displayed in window 306. For example, knowing that the user is interested in a particular ocean kayak, advertising material relating to kayak equipment and/or accessories may be presented for viewing. The advertising material may also include an option that enables the user to learn more about particular accessories or to purchase the accessories. Such can be presented, for example, in sub-window 402.

While the user is in the call queue, the user's position in the queue can be updated visually to show the user that they are advancing in the queue. Notice in this example that the user's position in the call queue 302 has advanced one position.

Product Brochures or Other Information

In one or more embodiments, product brochures or other information such as frequently asked questions (FAQs) can be displayed in window 306. With respect to product brochures, window 306 can be provided with controls to enable the user to page through the particular product brochure that might be associated with the ocean kayak in which they are interested.

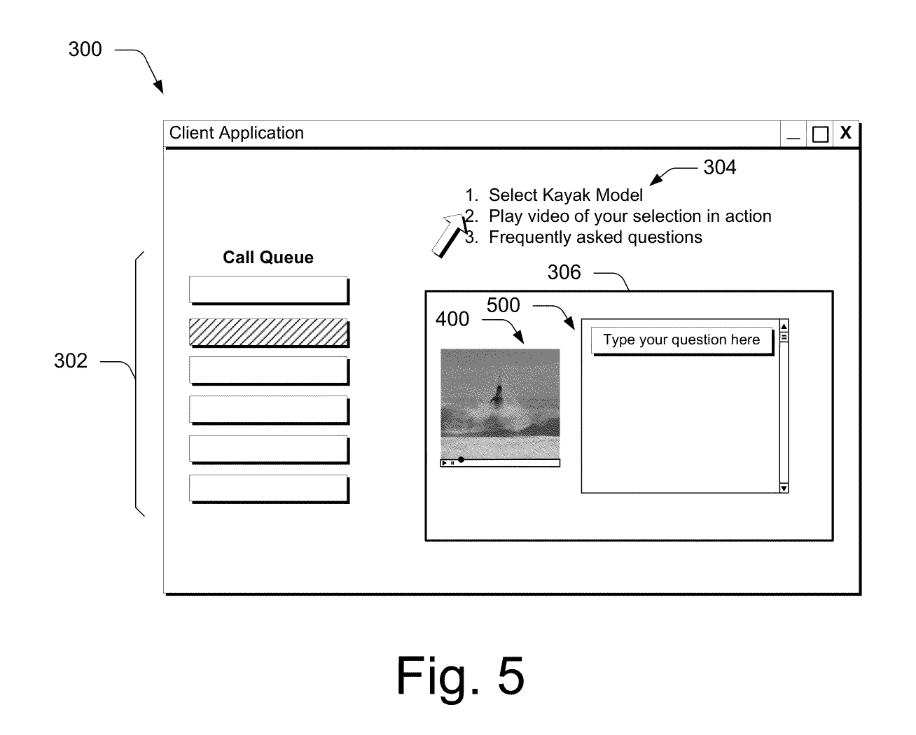

With respect to frequently asked questions (FAQs), such content can be presented within window 306 and the user can start searching in the event they have a particular question concerning the subject of their call. If, in the interim while waiting to be connected with an agent, the user finds an answer to their question, they can terminate the call. As an example, consider FIG. 5. There, user interface 300 is shown. Assume in this example that selections that are presented to the user include a selection in which they can select a kayak model, play video of a related model selection, and/or view frequently asked questions (FAQs). In this particular example, the user has opted to play video of their selected kayak model. Responsive to their selection, as in the above example, sub-window 400 with video controls is presented and a video of their selected kayak model is shown in action. Assume further, that the user selects to view frequently asked questions (FAQs). In this example, a sub window 500 is presented and the user can scroll through frequently asked questions or enter their own question in an input box, while in the call queue.

Product Customization Interfaces

In one or more embodiments, content presented within window 306 can enable the user to customize or design a product that they would like to purchase, while they wait in the call queue 302. For example, the user may be interested in a number of different features for the ocean kayak in which they are interested. In this example, a webpage or other interactive content presented within window 306 can enable the user to select from among these options and effectively build their custom ocean kayak. For example, the user may be able to select between colors, hull designs, lengths and other design parameters.

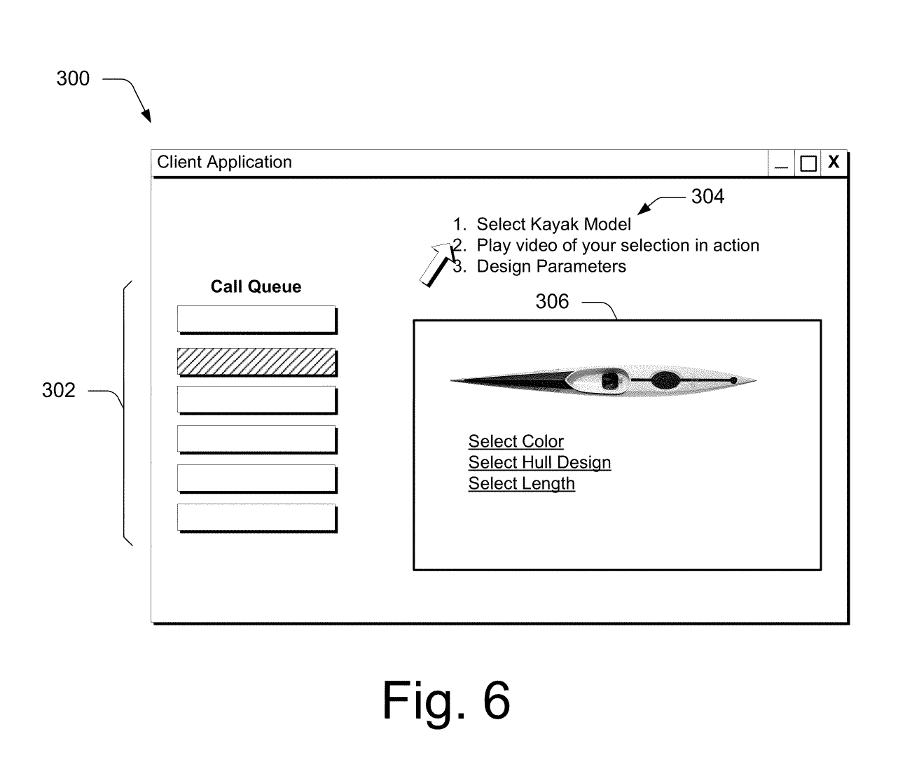

As an example, consider FIG. 6 which illustrates window 306. Here, a kayak design corresponding to the user's selection is displayed. In addition, a “Design Parameters” selection is displayed that enables the user to select between various parameters such as, by way of example and not limitation, color, hull design, and length. As the user makes their selection, the visualization of the display kayak can change to match their selections.

Virtual-Reality Interfaces

In one or more embodiments, content presented within window 306 can enable the user to experience a virtual reality interface associated with a subject of their call while they wait in the call queue 302.

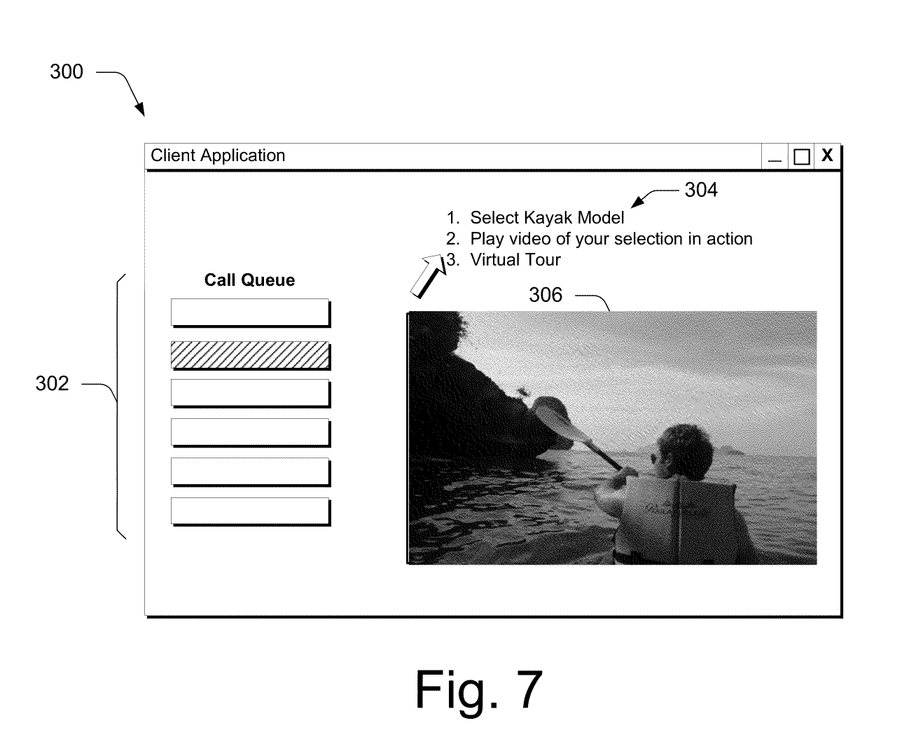

For example, consider the user above who has navigated to and is experiencing content associated with a potential purchase of a kayak. One of the options that can be displayed for the user is one which enables the user to experience a virtual kayak trip from the point of view of a kayak user. In this manner, the user can get a feel for the fluidic dynamics of the kayak. As an example, consider FIG. 7. There, user interface 300 is shown. Assume in this example that selections that are presented to the user include a selection in which they can select a kayak model, play video of a related model selection, and/or select a virtual tour. In this particular example, the user has opted to select a virtual tour of the selected kayak model. Responsive to their selection, window 306 is used to present a virtual tour of the user's selected kayak.

In another example, consider a user who has placed a call to a call center to learn about a new automobile that they may be interested in purchasing. After selecting certain options to design their automobile, the user can be presented with an interface selection that enables them to take their automobile for a virtual drive while they wait in the call queue 302.

In another example, consider a user who has placed a call to a life insurance company and is placed in a call queue. While in the call queue, their forward facing camera on the end user terminal can capture an image of the user and image processing software at an associated server can process the image of the user's face to age them so that the user can see what they look like at different ages, e.g., 40 years of age, 50 years of age, and so on.

Game Interfaces

In one or more embodiments, content presented within window 306 can enable the user to be exposed to a game interface, while they wait in the call queue 302. The game interface can serve to distract and/or amuse the user while they are waiting to be connected to an agent. Any suitable type of game can be utilized. For example, in at least some embodiments, the game can be related to the subject of the user's call. Alternately or additionally, the game might be unrelated to the user's call. Further, in at least some embodiments, the user can be presented with game selection options from which they can choose from amongst various different games. In this manner, interactive content can be presented to the user in a manner which reduces their perceived time in call queue 302. Further, recent popular games can be presented to the user which further serves to reinforce the notion that the callee has a current appreciation for modern trends.

Virtual Jukebox

In one or more embodiments, content presented within window 306 can enable the user to be presented with a virtual jukebox from which they can select music or music stations from a music provider, while they wait in the call queue 302. For example, in at least some embodiments, relevant call centers can partner with online music and music video providers to provide music or other multimedia content for users. This can also serve to enable such music and music video providers to advertise their products and services via window 306.

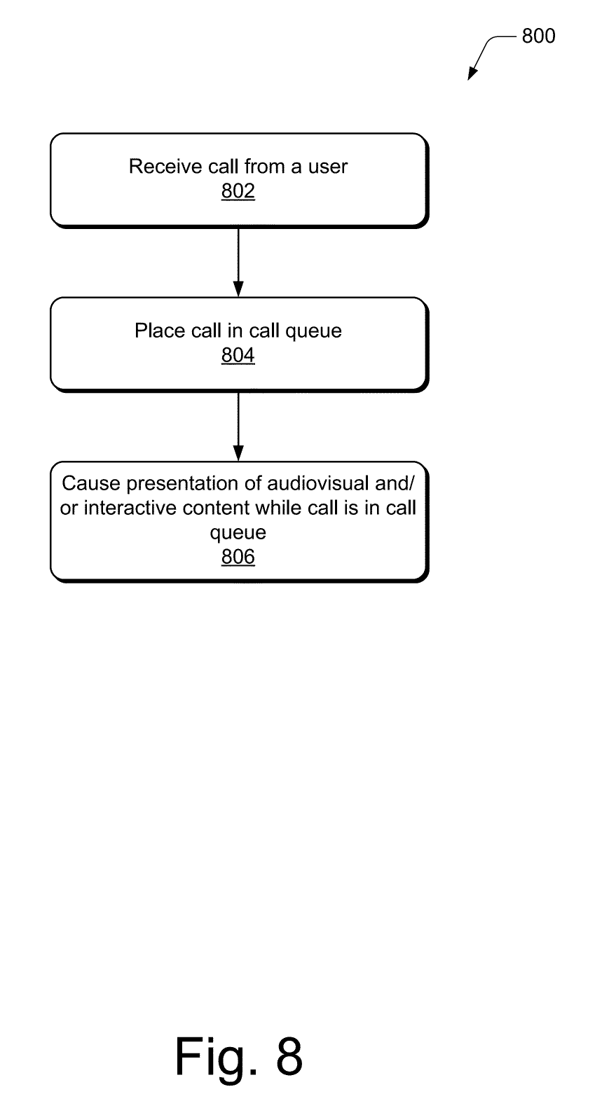

FIG. 8 is a flow diagram that describes steps in a method 800 in accordance with one or more embodiments. The method can be implemented in connection with any suitable hardware, software, firmware, or combination thereof. In at least some embodiments, the method can be implemented in suitably-configured software.

Step 802 receives a call from a user. This step can be implemented in any suitable way. For example, in at least some embodiments, the call can be received by an entity, such as a business entity, that maintains or otherwise utilizes a call queue. Step 804 places the call in the call queue. This step can be performed in any suitable way. For example, in at least some embodiments, a user can be given an option to have their call placed in a call queue. User selections can be received by way of any suitably-configured user interface, examples of which are provided above. Step 806 causes presentation of audiovisual and/or interactive content while the call is in the call queue. Examples of how this can be done are provided above. For example, in at least some embodiments, a user can be given a number of different selection options from which to choose and, responsive to a user selection, audiovisual and/or interactive content can be displayed for the user in their client application's user interface.

Using Caller Information to Influence Presentation of Material

In the above examples, the user was provided with various selection options to drive selection of the audiovisual and/or interactive content to be displayed while in the call queue. In at least some embodiments, the system can automatically determine content to display for a user when the user's call is placed in the call queue without a user making any selections. Any suitable techniques can be utilized to automatically determine audiovisual and/or interactive content to display to the user.

In at least some embodiments, the call system that users use to place calls, or other entities, can maintain profile information about its various users. The profile information can include any type of information that the user chooses to provide. For example, the profile information may include information about a user's content preferences such as music genres, favorite artists, hobbies and interests. In these instances, when a call is received from a user, the user's profile information can be consulted and content for display to the user can be selected based upon information in the user's profile. The profile information can be associated with a particular user through the use of an identifier, such as a caller ID, associated with the user.

In addition, in at least some embodiments, user interface instrumentalities can be presented to enable the user to skip through or otherwise deselect content that is displayed for them, e.g., advertising material and the like. Responsive to user interaction with this content, information can be gathered about the user's preferences and the user's profile information can be updated to reflect the user's current choices. This updated profile information can form the basis for future automatic selections when a call is received from the corresponding user.

In at least some embodiments, information other than, or in addition to that information described above, can be utilized to cause presentation of audiovisual and/or interactive content to the user. For example, when a call is received from a user and placed into a queue, cookie and page information associated with the user's browsing history can be utilized to select content to present to the user when their call is placed in the call queue. For example, if the user frequents a particular sporting site, such can be gleaned from the cookie and page information of the user. Accordingly, video clips from the particular sporting site can be presented to the user when their call is placed into the call queue.

Having considered various embodiments, consider now an example system and aspects of other devices that can be utilized to implement the embodiments described above.

Example System and Devices

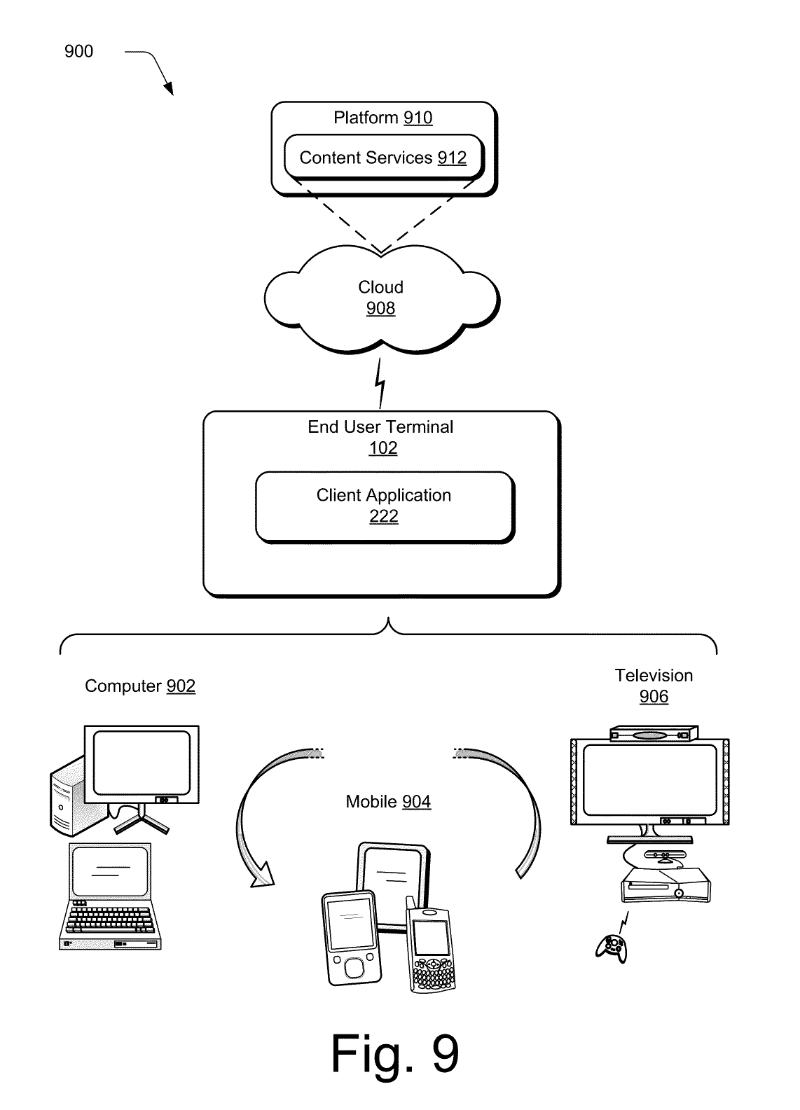

FIG. 9 illustrates an example system 900 that includes the end user terminal 102 as described with reference to FIG. 1. The example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the end user terminal 102 may assume a variety of different configurations, such as for computer 902, mobile 904, and television 906 uses. Each of these configurations includes devices that may have generally different constructs and capabilities, and thus the end user terminal 102 may be configured according to one or more of the different device classes. For instance, the end user terminal 102 may be implemented as the computer 902 class of a device that includes a personal computer, desktop computer, a multi-screen computer, laptop computer, netbook, and so on. Each of these different configurations may employ the techniques described herein, as illustrated through inclusion of the client application 222 which can serve to enable a user to make calls as described above.

The end user terminal 102 may also be implemented as the mobile 904 class of device that includes mobile devices, such as a mobile phone, portable music player, portable gaming device, a tablet computer, a multi-screen computer, and so on. The end user terminal 102 may also be implemented as the television 906 class of device that includes devices having or connected to generally larger screens in casual viewing environments. These devices include televisions, set-top boxes, gaming consoles, and so on. The techniques described herein may be supported by these various configurations of the end user terminal 102 and are not limited to the specific examples the techniques described herein.

The cloud 908 includes and/or is representative of a platform 910 for content services 912. The platform 910 abstracts underlying functionality of hardware (e.g., servers) and software resources of the cloud 908. The content services 912 may include applications and/or data that can be utilized while computer processing is executed on servers that are remote from the end user terminal 102. Content services 912 can be provided as a service over the Internet and/or through a subscriber network, such as a cellular or Wi-Fi network.

The platform 910 may abstract resources and functions to connect the end user terminal 102 with other computing devices. The platform 910 may also serve to abstract scaling of resources to provide a corresponding level of scale to encountered demand for the content services 912 that are implemented via the platform 910. Accordingly, in an interconnected device embodiment, implementation of functionality described herein may be distributed throughout the system 900. For example, the functionality may be implemented in part on the end user terminal 102 as well as via the platform 910 that abstracts the functionality of the cloud 908.

### CONCLUSION

Various embodiments can utilize audiovisual and/or interactive content to present to a caller when the caller's call is placed into a call queue. A variety of different types of content can be presented to the caller to reduce the caller's perceived time in the call queue. In at least some embodiments, content presented to a particular caller can be driven by caller selections. Alternately or additionally, content presented to a particular caller can be automatically selected for the caller based upon information associated with the caller such as the caller's profile and/or information associated with the caller's previous content consumption patterns.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

1. A computer-implemented method comprising:
receiving a call from a user based on an action associated with a product or service;
placing the call in a call queue;
while the call is in the call queue, causing presentation of selectable options that are selectable to initiate presentation of different types of interactive content by a client application that include content associated with the product or service that is associated with the action that initiated the call by the user; and
causing presentation of visual interactive content by a client application while the call is in the call queue, the presentation of visual interactive content being caused responsive to user selection of at least one of the selectable options that are presented to the user while the call is in the call queue.

2. The method of claim 1, wherein said causing is performed responsive to receiving a user selection of one or more selection options.

3. (canceled)

4. The method of claim 1, wherein said multiple different types of interactive content are presented based on profile information associated with the user.

5. The method of claim 1, wherein said multiple different types of interactive content are presented based on cookie or page information associated with a user's browsing history.

6. The method of claim 1, wherein said content comprises promotional or informational videos.

7. The method of claim 1, wherein said call is associated with a product, and said content comprises information associated with the product.

8. The method of claim 1, wherein said content comprises a product customization interface.

9. The method of claim 1, wherein said content comprises a virtual reality interface.

10. The method of claim 1, wherein said content comprises a game interface.

11. The method of claim 1, wherein said content comprises a virtual jukebox.

12. One or more computer-readable storage memory devices embodying computer readable instructions, which, when executed, implement a client application configured to enable a user to place a call, the client application comprising:
a user interface configured to enable a user to initiate the call based on an action associated with a product or service;
a call queue configured to visually illustrate the call's place in the call queue;
an options section that provides multiple options for a user to select while the call is in the call queue, said multiple options being selectable to cause presentation of multiple different types of visually interactive content within the user interface, the multiple different types of visually interactive content including content associated with the product or service that is associated with the action that initiated the call by the user.

13. The one or more computer-readable storage memory devices of claim 12, wherein the visually interactive content comprises content associated with information in a user profile.

14. The one or more computer-readable storage memory devices of claim 12, wherein the multiple options comprise options associated with a product.

15. The one or more computer-readable storage memory devices of claim 12, wherein the multiple options comprise options associated with viewing a video of an associated product.

16. The one or more computer-readable storage memory devices of claim 12, wherein the multiple options comprise options associated with frequently asked questions (FAQs).

17. The one or more computer-readable storage memory devices of claim 12, wherein the multiple options comprise options associated with designing a product.

18. The one or more computer-readable storage memory devices of claim 12, wherein the multiple options comprise options associated with a virtual presentation.

19. A system comprising:
an end user terminal comprising one or more processors;
one or more computer readable storage media; and
computer readable instructions embodied on the one or more computer readable storage media which, when executed under the influence of the one or more processors, implement a method comprising:
presenting a user interface at the end user terminal in association with a call from the end user terminal to an entity; and
presenting an options section that provides multiple options for a user to select when the call is placed, the multiple options including a selectable option for a user to opt to be added to a call queue, the options section being configured to provide additional options while the call is in the call queue, said additional options being selectable to cause presentation of multiple different types of visually interactive content while the call is in the call queue.

20. The system of claim 19, wherein presentation of the visually interactive content is configured to occur within the user interface.

21. The system of claim 19, wherein the multiple different types of visually interactive content include content associated with a product or service that is associated with an action that initiated the call from the end user terminal.
